(19) United States
(12) Patent Application Publication
(10) Pub. No.: US 2026/0021785 A1
(43) Pub. Date: Jan. 22, 2026

(54) Method For Joining Joining Parts And Joining Tool

(71) Applicant: Lisa Draexlmaier GmbH, Vilsbiburg (DE)

(72) Inventors: Martin RITTHALER, Gangkofen (DE); Robert PUSL, Moosburg (DE)

(73) Assignee: Lisa Dräxlmaier GmbH, Vilsbiburg (DE)

(21) Appl. No.: 19/273,436

(22) Filed: Jul. 18, 2025

(30) Foreign Application Priority Data
Jul. 18, 2024 (DE) 10 2024 120 373.0

(51) Int. Cl. B60R 21/215; B29C 65/00

(52) U.S. Cl. CPC B60R 21/215; B29C 66/7392; B29C 66/8322

(57) ABSTRACT

A method is disclosed for joining joining parts, preferably an airbag firing channel with a cover part, with a melting step in which a first joining surface of the first joining part, preferably the cover part joining surface, is melted and/or plasticized by means of at least one infrared emitter of the joining tool and in which a second joining surface of the second joining part, preferably the runner channel joining surface, is melted and/or plasticized by means of at least one heating element of the joining tool.

### CROSS REFERENCE TO RELATED APPLICATIONS

This application claims priority to German Patent Application DE102024120373.0 filed on Jul. 18, 2024 at the German Patent Office, the content of which is incorporated herein by reference.

### BACKGROUND OF THE INVENTION

### Field of the Invention

The present invention relates to a method for joining parts to be joined and a joining tool.

### Description of Related Art

In the modern motor vehicle, an airbag discharge channel in the area of an instrument panel is typically covered by a cover part. For this purpose, the cover part is welded to the airbag discharge channel in a process for joining the airbag discharge channel to the cover part by means of infrared welding or, alternatively, by means of heating element welding. However, both welding methods have specific disadvantages. For example, compared to heating element welding, infrared welding exerts a higher joining pressure on the airbag channel and cover parts, resulting in greater component distortion of the parts to be joined.

### BRIEF SUMMARY OF THE INVENTION

An objective of the invention disclosed herein is to provide a method for joining parts that can be carried out quickly and with minimal distortion of and/or to the parts being joined.

The invention relates to a method for joining joining parts. The parts are preferably to and/or for an airbag discharge channel with a cover part. The method includes a preparation step in which a first joining part, preferably an airbag discharge channel, and a second joining part, preferably a cover part, and a joining tool are provided. The method further includes an arrangement step in which the first joining part and the second joining part are arranged at a distance from one another by an intermediate gap. A joining tool is arranged in the intermediate gap between a first joining surface of the first joining part, preferably a cover part joining surface of the cover part, and a second joining surface of the second joining part, preferably a shot channel joining surface of the airbag shot channel. The method further includes a melting step, in which the first joining surface, preferably the cover part joining surface, is melted and/or plasticized by means of at least one infrared emitter of the joining tool and in which the second joining surface, preferably the shot channel joining surface, is melted and/or plasticized by means of at least one heating element of the joining tool. The method still further includes a joining step in which the melted and/or plasticized first joining surface, preferably the cover part joining surface, is pressed against the melted and/or plasticized second joining surface, preferably the shot channel joining surface, under the action of a joining pressure force to form a joined assembly. The joined assembly is pressed to form a material-locking joint between the first and second joining surfaces, preferably the shot channel joining surface, to form a joined assembly. The joined assembly is cooled to form a material-locking joint between the first joining surface, preferably the cover joining surface, and the second joining surface, preferably the shot channel joining surface. The fact that, in the method, the first joining surface is melted and/or plasticized by means of the infrared emitter and the second joining surface by means of the heating element combines the advantages of the infrared emitter and the heating element in a single method and/or joining tool. With this method, the two joining parts can thus be joined together quickly and with low component distortion.

By way of example, it is envisaged that, during the arrangement step, the second joining surface, preferably the shot channel joining surface, is brought into flat contact with the heating element of the joining tool, it being preferably provided that, preferably after completion of the positioning step and/or during the melting step, the second joining surface, preferably the shot channel joining surface, is in heat-conducting connection with the heating element of the joining tool.

It is preferred that the joining tool has both the infrared emitter and the heating element, and/or that during the melting step both the cover part joining surface and the shot channel joining surface are melted and/or plasticized.

For example, it is provided that the material of the first joining part comprises plastic, and/or that the material of the second joining part comprises plastic.

In order to ensure that the joining surfaces can be pressed against each other without interference from contours during the joining step, an embodiment of the present invention provides that the method includes a removal step in which the joining tool is removed from the intermediate gap between the first joining surface, preferably the cover part joining surface, and the second joining surface, preferably the shot channel joining surface, is removed, and preferably pulled out.

In order to be able to melt the second joining surface quickly and efficiently by means of the heating element, a preferred embodiment provides that the second joining surface, preferably the shot channel joining surface, is at least partially formed by preferably plate-shaped ribs which are connected to a base body section of the second joining part, preferably to a base body section of the airbag firing channel, and/or are formed on the base body section.

In order to be able to melt the first joining surface quickly and efficiently by means of the infrared emitter, an exemplary embodiment provides that the first joining surface, preferably the cover part joining surface, has a smooth surface and/or that the first joining surface, preferably the cover part joining surface, is free of ribs.

In order to be able to manufacture the second joining part in a cost-effective manner, in an embodiment of the present invention, the second joining part, preferably the airbag discharge channel, is an injection-molded component, and/or that the second joining part, preferably the airbag discharge channel, is preferably essentially ring-shaped, and/or that the second joining part, preferably the airbag discharge channel, delimits a passage, preferably an airbag passage, to the outside.

In order to make the first joining part haptically appealing and durable, an embodiment of the present invention provides that the first joining part, preferably the cover part, has a natural fiber mat or an injection-molded component, and/or that the first joining part, preferably the cover part, is formed by a natural fiber mat or an injection-molded component with a geometry preferably injection-molded in an injection molding process.

In order to be able to design the joining tool compactly, an exemplary embodiment provides that the heating element of the joining tool is preferably essentially plate-shaped, and/or that the infrared emitter of the joining tool has a heating coil, preferably electrically activatable.

Further to another embodiment of the present invention, a joining tool with a carrier element and at least one infrared emitter and at least one heating element, wherein the infrared emitter is arranged on a first cover surface of the carrier element and the heating element, is arranged on a second cover surface of the carrier element. The advantages of the method apply analogously to the joining tool.

In order to be able to melt and/or plasticize both the first joining part and the second joining part in a single step, for example the melting step, a preferred embodiment provides that the first cover surface extends parallel to the second cover surface and/or that the first cover surface and the second cover surface are arranged on opposite sides of the carrier element.

In order to be able to design the joining tool compactly, in an exemplary embodiment, the carrier element is preferably essentially plate-shaped, and/or the heating element is preferably essentially plate-shaped, and/or the infrared emitter has a heating coil, preferably electrically activatable.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts, in a side sectional view, an arrangement of a cover part, an airbag discharge channel, and a joining tool after completion of an arrangement step;

FIG. 2 depicts, in a side sectional view, the cover part melted by means of the joining tool and the airbag discharge channel melted by means of the joining tool, and

FIG. 3 depicts, in a side sectional view, the cover part and the airbag discharge channel after completion of a joining step.

FIG. 4 depicts, in a schematic flow diagram, the sequence of steps of the method for joining the parts, including the preparation step, arrangement step, melting step, removal step, and joining step.

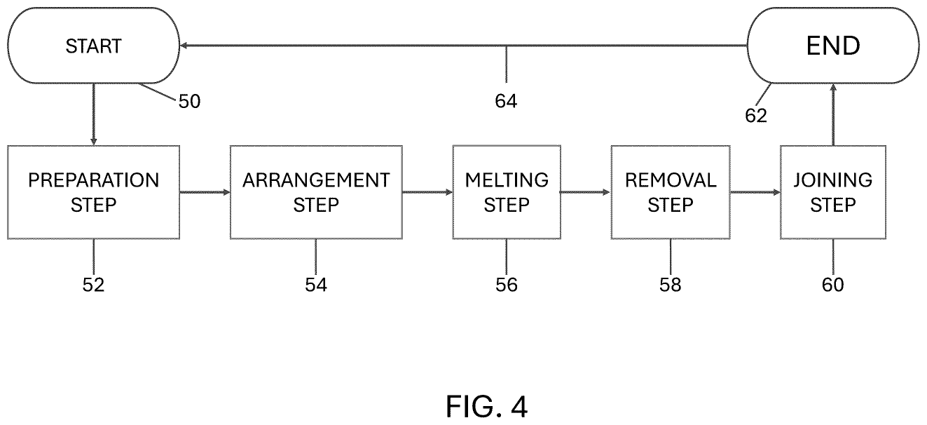

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should not be understood as including only one of A, only one of B, only one of C, or any combination of A, B, and C.

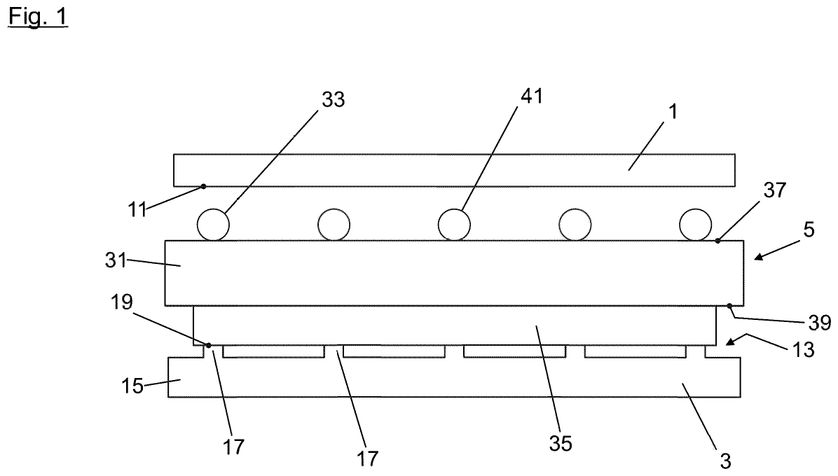

FIG. 1 shows a first joining part 1, a second joining part 3, and a joining tool 5. The first joining part 1 is depicted, by way of example, in the form of a cover part for an airbag ejection channel. The second joining part 3 is depicted, by way of example, in the form of an airbag ejection channel. The material of the first joining part 1 may comprise, at least partially, a plastic. The material of the second joining part 3 may comprise, at least partially, a plastic.

The first joining part 1 has a first joining surface 11. The first joining surface 11 is shown here only as an example by a cover part joining surface of the cover part. The first joining surface 11 has a smooth surface and is therefore free of ribs, for example. The first joining part 1, preferably the cover part, can be formed by a natural fiber mat with a geometry injection molded in an injection molding process.

The second joining part 3 is essentially ring-shaped and delimits a passage (not shown), preferably an airbag passage, completely or almost completely to the outside. The second joining part 3 may be formed by an injection-molded component and include a second joining surface 13. The second joining surface 13 may be formed by a shot channel joining surface of the airbag shot channel. The second joining part 3 includes a base body section 15 and several plate-shaped ribs 17 made of the same material and are connected in one piece to the base body section 15 as well as project from the base body section 15 at essentially right angles. The second joining surface 13 may be formed, at least partially, by the ribs 17, as well as the upper rib cover surfaces 19 of the ribs 17 facing away from the base body section 15.

The joining tool 5 may have a plate-shaped carrier element 31 and an infrared emitter 33. In addition, the joining tool 5 may have a plate-shaped and/or electrically activatable and/or electrically heatable heating element 35. The carrier element 31 is arranged between the infrared emitter 33 and the heating element 35. The infrared emitter 33 is fastened and/or arranged on a first cover surface 37 of the carrier element 31. The heating element 35 is fastened and/or arranged on a second cover surface 39 of the carrier element 31 opposite the first cover surface 37. The first cover surface 37 extends essentially parallel to the second cover surface 39. The infrared emitter 33 may be an electrically activatable and/or electrically heatable heating coil 41.

A method for joining the two joining parts, i.e. the first joining part 1 and the second joining part 3, using the joining tool 5 will now be described hereinbelow. The method starts 50 and then proceeds to a preparation step 52, followed by an arrangement step 54, followed by a melting step 56, followed by a removal step 58, and followed by a joining step 60. The method may then end 62 or return 64 to start 50.

After the start 50, in the preparation step 52, the first joining part 1, the second joining part 3, and the joining tool 5 are first prepared. The arrangement step 54 is carried out promptly after the preparation step. In the arrangement step 54, the first joining part 1 and the second joining part 3 are positioned at a distance from each other by an intermediate gap. In addition, in the arrangement step 54, the joining tool 5 is positioned in the intermediate gap between the first joining surface 11 and the second joining surface 13, and may preferably be retracted. The second joining surface 13 is brought into flat contact with the heating element 35 of the joining tool 5 so that the heating element 35 is in heat-conducting connection with the second joining surface 13. A current state of the method thus far is depicted in FIG. 1.

The melting step 56 is carried out promptly after the arrangement step 54. In the melting step 56, the first joining surface 11 is melted and/or plasticized by means of the infrared emitter 33. In addition, in the melting step 56, the second joining surface 13 is melted and/or plasticized simultaneously or almost simultaneously by means of the heating element 35.

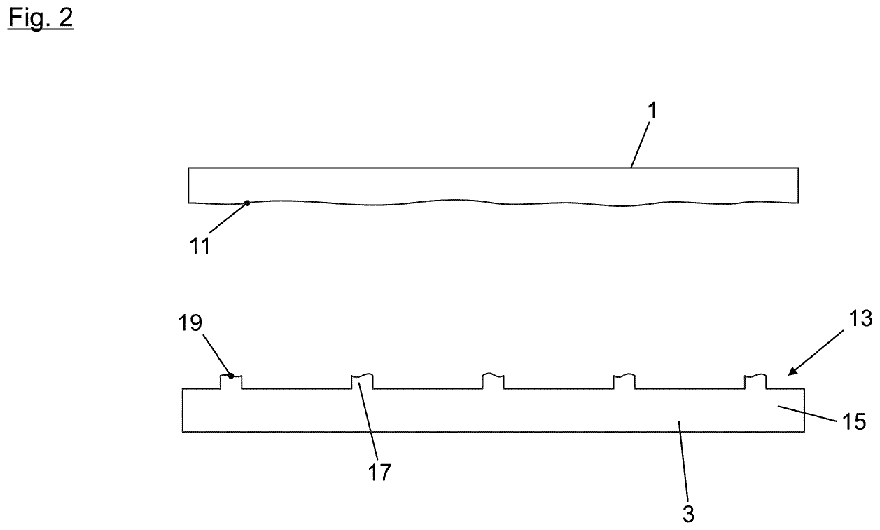

The removal step 58 is performed promptly after the melting step 56. In the removal step 58, the joining tool 5 is removed from the intermediate gap between the first joining surface 11 and the second joining surface 13, preferably by being pulled out of the intermediate gap. A current state of the method thus far is depicted in FIG. 2.

The joining step 60 is performed promptly after the removal step 58. In the joining step 60, the melted and/or plasticized first joining surface 11 is pressed against the melted and/or plasticized second joining surface 13 under the action of a joining pressure force F to form a joined assembly. In addition, during the joining step, the joint is cooled to form a material-locking joint between the first joining surface 11 and the second joining surface 13.

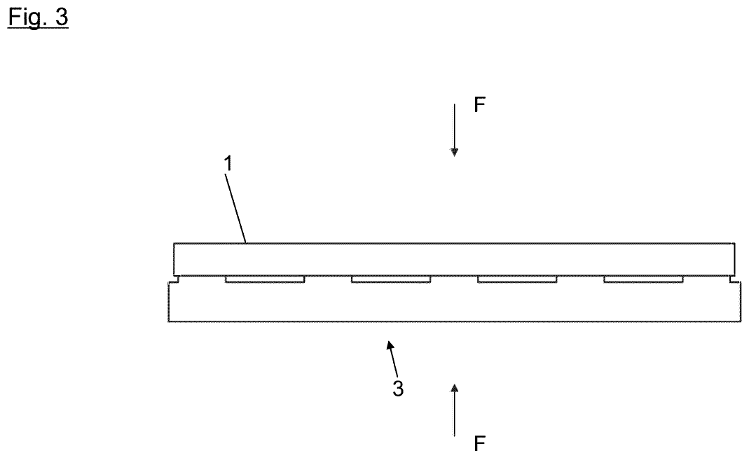

After completion of the joining step, the first joining part 1 is material-locked to the second joining part 3. A current state of the method thus far is depicted in FIG. 3. The method may then end 62 or return 64 to start 50.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary.

What is claimed is:

1. A method for joining parts associated with an airbag firing channel with a cover part, comprising the steps of:
providing, in a preparation step, a first joining part having a first surface, a second joining part having a second surface, and a joining tool;
arranging, in an arrangement step, the first joining part at a distance to the second joining part so as to form an intermediate gap between the first joining part and the second joining part, and arranging a joining tool in the intermediate gap between the first joining surface and the second joining surface, the joining tool comprising at least one infrared emitter and at least one heating element;
melting and/or plasticizing, in a melting step, the first joining surface with the at least one infrared emitter and the second joining surface with the at least one heating element, and
pressing, in a joining step, the melted and/or plasticized first joining surface against the melted and/or plasticized second joining surface with a joining pressure force so as to form a joined assembly, and cooling the joined assembly to form a material-locking joint between the first joining surface and the second joining surface.

2. The method according to claim 1, further comprising the steps of removing, in a removal step, before the joining step begins, the joining tool from the intermediate gap.

3. The method according to claim 1, wherein the second joining surface, preferably the firing channel joining surface, is formed at least partially by preferably plate-shaped ribs which are connected to a base body section of the second joining part preferably on a base body section of the airbag shot channel, and/or are formed on the base body section.

4. The method according to one claim 1, wherein the first joining surface, preferably the cover part joining surface, has a smooth surface, and/or that the first joining surface, preferably the cover part joining surface, is free of ribs.

5. The method according to claim 1, wherein the second joining part, preferably the airbag discharge channel, is an injection-molded component, and/or in that the second joining part, preferably the airbag discharge channel, is preferably substantially annular, and/or in that the second joining part, preferably the airbag discharge channel, delimits a passage, preferably an airbag passage, to the outside.

6. The method according to claim 1, wherein the first joining part, preferably the cover part, has a natural fiber mat, and/or that the first joining part, preferably the cover part, is formed by a natural fiber mat or an injection-molded component with preferably a geometry injection-molded in an injection molding process.

7. The method according to claim 1, wherein the heating element of the joining tool is preferably essentially plate-shaped, and/or in that the infrared emitter of the joining tool has a heating coil which is preferably electrically activatable.

8. A joining tool comprising:
a carrier element comprising a first cover surface and a second cover surface,
at least one infrared emitter, and
at least one heating element,
wherein the infrared emitter is arranged on the first cover surface, and
wherein the heating element is arranged on the second cover surface.

9. The joining tool according to claim 8, wherein:
the first cover surface extends parallel to the second cover surface; and/or
the first cover surface and the second cover surface are arranged on opposite sides of the carrier element.

10. The joining tool according to claim 8, wherein:
the carrier element is preferably essentially plate-shaped, and/or
the heating element is preferably essentially plate-shaped, and/or
the infrared emitter comprises a heating coil and is configured to be preferably activated electrically.

11. The method according to claim 2, wherein the step of removing comprises the step of pulling the joining tool from the intermediate gap.

12. The method according to claim 11, wherein the joining tool is removed from between a cover part joining surface of the first joining surface and a feed channel joining surface of the second joining surface.
